(19) United States
(12) Patent Application Publication
(10) Pub. No.: US 2010/0197283 A1
(43) Pub. Date: Aug. 5, 2010

(54) LINGUISTIC CONTENT MANAGEMENT METHOD AND SYSTEM, AND LINGUISTIC CONTENT TRANSMITTING APPARATUS AND LINGUISTIC CONTENT RECEIVING APPARATUS

(75) Inventor: Takuo YAMAMOTO, Ashigarakami-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/694,767

(22) Filed: Jan. 27, 2010

(30) Foreign Application Priority Data
Feb. 2, 2009 (JP) JP2009-021666

(51) Int. Cl. H04M 3/42; H04L 12/28

(52) U.S. Cl. 455/414.1; 370/401; 455/556.1

(57) ABSTRACT

An image data acquired by imaging an important document by an information terminal such as a mobile phone is securely transmitted to a desired destination in a public network. A document printed on a piece of paper or the like is imaged by the mobile phone, the acquired document image is transmitted to a transmitting server via a mobile communication network, the transmitting server transmits the document image to the receiving server via a VPN in the Internet, and the receiving server stores the document image received from the transmitting server. Since unauthorized acquisition and alteration of the document image in a mobile communication network and the VPN are substantially impossible, the document image taken by the mobile phone can be securely transmitted to the remote receiving server.

### BACKGROUND OF THE INVENTION

1. Field of the Invention

The present invention relates to a technique for securely transmitting an important document, audio and another linguistic content from a mobile phone and another information-communication terminal to a desired computer via the Internet and another public network.

2. Description of the Related Art

In Japanese Patent Application Laid-Open No. 2002-352190, a mobile phone displays image data of a target object taken by a camera on a display unit, scope of a text region included in the image data is designated through an key input unit, and the image data and scope information of the designated text region are transmitted to an image processing server via a communication network N. The image processing server recognizes characters included in the image data received from the mobile phone and converts the image into text data by a character recognition function that is internally included, and transmits the text data to the mobile phone. The mobile phone receives the text data transmitted from the image processing server.

In Japanese Patent Application Laid-Open No. 2005-134968, a CCD camera takes an image of a subject, and causes a memory to store the acquired image data. A display image generation unit reads the image data stored in the memory, and causes an LCD to display the image. A user operates an operation unit and selects a starting point and an end point of the image to be recognized, while watching the display. An image processing/character recognition unit recognizes characters in the selected image region, and causes the memory to store the recognition result. A display image generation unit reads character string data of the character recognition result stored in the memory, and causes the LCD to display the data. This technique can be applied to a mobile information terminal device such as a mobile phone.

In WO2004/109587, character recognition is performed on a prescribed region in the image taken by the mobile phone camera, and the result is displayed.

In Japanese Patent Application Laid-Open No. 2002-41502, at a site of a destination, digital image data and audio data having been collected by a user using a mobile information device (terminal) such as a digital camera, a camera-equipped PDA and a mobile personal computer is transmitted via a network, and received by a server that processes data. The server edits the received digital image data into a prescribed document format, and also pastes the received audio data in a prescribed region in the above-mentioned document format as an audio code image or a text image. The document attached with the image and the text or audio code is stored in a recording medium as a report for a specific purpose, printed as a paper document, or transmitted to a specific site via the network.

In Japanese Patent Application Laid-Open No. 2008-139996, data in a portable information terminal is separated as data associated with some module, such as an application to be executed on the information terminal, and as an image file. Secret Sharing Scheme is applied to an image file and a plurality of share files are created. The share files are separately stored in the information terminal and a mobile communication terminal capable of wireless communication or a management server. In case that the information terminal is lost or stolen, the share file saved in the mobile communication terminal is deleted by remote control using a wireless communication function of the mobile communication terminal, thereby achieving an effect equivalent to a case where important data in the information terminal has completely been deleted.

Japanese Patent Application Laid-Open Nos. 2002-352190, 2005-134968 and 2002-41502 and WO2004/109587 lack consideration pertaining to security when data is transmitted to the server. According to Japanese Patent Application Laid-Open No. 2008-139996, the file cannot be deleted when remote control is impossible.

### SUMMARY OF THE INVENTION

It is an object of the present invention to securely transmit image data acquired by taking an image of an important document by a mobile phone or another information terminal and audio data acquired by recording an important conversation to a desired destination in a public network.

In a linguistic content management method according to the present invention, an information-communication terminal executes a step of acquiring a linguistic content including data representing information by language, and a step of connecting to a transmitting server pursuant to a prescribed communication standard of a mobile communication carrier and transmitting the linguistic content to the transmitting server, the transmitting server executes a step of receiving the linguistic content pursuant to the prescribed communication standard of the mobile communication carrier, and a step of connecting to a receiving server via a virtual dedicated communication path in a public network and transmitting the linguistic content to the receiving server, and the receiving server executes a step of receiving the linguistic content via the virtual dedicated communication path, and a step of saving the received linguistic content.

The information-communication terminal preferably executes a step of transmitting identification information of the information-communication terminal with the linguistic content, and the transmitting server executes a step of storing destination information corresponding to the identification information of each information-communication terminal in a destination database, a step of receiving the identification information of the information-communication terminal with the linguistic content pursuant to the prescribed communication standard of the mobile communication carrier, and a step of transmitting the linguistic content to the receiving server identified by the destination information corresponding to the received identification information in the transmitting database.

The transmitting server preferably executes a step of transmitting the identification information of the information-communication terminal with the linguistic content, and the receiving server executes a step of storing storage destination information corresponding to the identification information of each information-communication terminal in a storage destination database, a step of receiving the identification information of each information-communication terminal with the linguistic content via the virtual dedicated communication path, and a step of storing the linguistic content in a storage destination identified by the storage destination information corresponding to the received identification information in the storage destination database.

The information-communication terminal preferably executes a step of deleting the linguistic content transmitted to the transmitting server, from a prescribed storage medium.

According to this configuration, the document image does not remain in the information-communication terminal, thereby obviating unauthorized usage.

The information-communication terminal preferably executes a step of displaying an imaging angle of view when taking an image of a subject including a document.

The information-communication terminal preferably executes a step of displaying the acquired linguistic content.

The information-communication terminal preferably executes a step of transmitting the linguistic content to the transmitting server responsive to input of an instruction of transmitting the acquired linguistic content.

The linguistic content preferably includes at least any one of an image data acquired by taking an image of a subject including a document and audio data representing a collected speech content.

A linguistic content management system according to the present invention, comprises: an information-communication terminal that includes a linguistic content acquisition device that acquires a linguistic content including data representing information by language, and a terminal transmitter device that connects to a transmitting server pursuant to a prescribed communication standard of a mobile communication carrier and transmits the linguistic content to the transmitting server; the transmitting server that includes a transmitting server receiver that receives the linguistic content pursuant to the prescribed communication standard of the mobile communication carrier, and a transmitting server transmitter that connects to a receiving server via a virtual dedicated communication path in a public network and transmits the linguistic content to the receiving server; and the receiving server that includes a receiving server receiver that receives the linguistic content via the virtual dedicated communication path, and a saving device that saves the received linguistic content.

The virtual dedicated communication path preferably includes a VPN (Virtual Private Network).

Preferably, the system further comprises a communication path establishment device that establishes the virtual dedicated communication path with the transmitting server.

The communication path establishment device preferably limits an access path originating from the public network and bound for the receiving server to the virtual dedicated communication path.

The communication path establishment device is preferably a gateway provided between the public network and a LAN (Local Area Network) to which the receiving server is connected, and an access path from the transmitting server to the receiving server via the public network and the LAN is limited to the virtual dedicated communication path.

The transmitting server preferably executes a step of receiving from an information-communication terminal a linguistic content including data representing information by language pursuant to a prescribed communication standard of a mobile communication carrier, and a step of connecting to a receiving server via a virtual dedicated communication path in a public network and transmitting the linguistic content to the receiving server.

The receiving server preferably executes a step of receiving the linguistic content via the virtual dedicated communication path, and a step of saving the received linguistic content.

The present invention also includes a programmable storage medium tangibly embodying a program of machine-readable instructions to the transmitting server to execute the linguistic content management method.

The present invention also includes a programmable storage medium tangibly embodying a program of machine-readable instructions to the receiving server to execute the linguistic content management method.

A linguistic content transmitting apparatus according to the present invention comprises: a receiver that receives from an information-communication terminal a linguistic content that is content data representing information by language pursuant to a prescribed communication standard of a mobile communication carrier; and a transmitter that connects to a linguistic content receiving apparatus via a virtual dedicated communication path in a public network and transmits the linguistic content received by the receiver to the linguistic content receiving apparatus.

A linguistic content receiving apparatus according to the present invention comprises: a linguistic content receiver that receives the linguistic content from the above-mentioned linguistic content transmitting apparatus via the virtual dedicated communication path; and a saving device that saves the linguistic content received by the linguistic content receiver.

Preferably, the apparatus further comprises a document data converter that converts a document included in the linguistic content received by the linguistic content receiver into document data and outputs the document data. The saving device saves the document data outputted by the document data converter.

The present invention takes an image of a document printed on a piece of paper or the like by the information communication terminal, and transmits the acquired document image to the transmitting server via the network of the mobile communication carrier. The transmitting server transmits the document image to the receiving server via the virtual dedicated communication path on the public network. The receiving server saves the document image received from the transmitting server. Since unauthorized acquisition and alteration of the document image in the network of the mobile communication carrier and the virtual dedicated communication path are difficult, the document image taken by the information-communication terminal can be securely transmitted to the remote receiving server. Likewise, the audio collected by the information-communication terminal can securely be transmitted to the remote receiving server.

### BRIEF DESCRIPTION OF THE DRAWINGS

FIG. 1 is a diagram showing a schematic configuration of an imaged document management system;

FIG. 2 is a diagram showing an example of a live view image;

FIG. 3 is a diagram showing an example of a taken document image;

FIG. 4 is a diagram showing an example of information stored in a transmitting DB;

FIG. 5 is a diagram showing an example of information stored in a receiver DB;

FIG. 6 is a diagram showing an document file; and

FIG. 7 is a flowchart of processing in the imaged document management system.

### DETAILED DESCRIPTION OF THE PREFERRED EMBODIMENTS

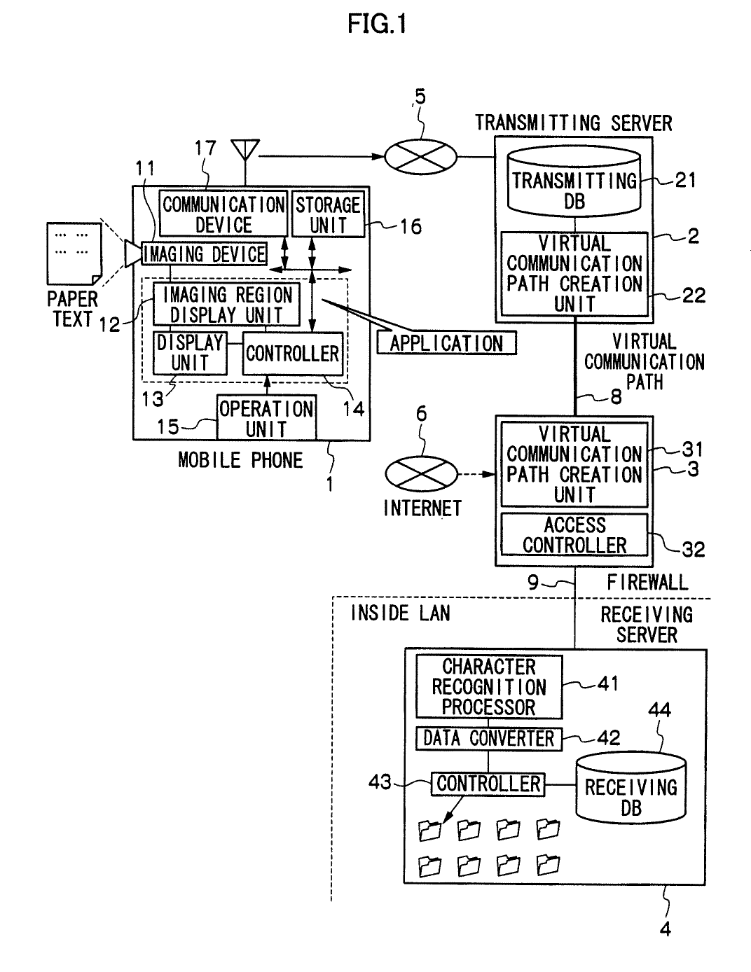

FIG. 1 shows a schematic configuration of an imaged document management system according to a preferred embodiment of the present invention. This system includes a mobile phone 1, a transmitting server 2, a firewall 3 (hereinafter represented as FW 3) and a receiving server 4. A main purpose of this system is to take an image of a document, as a subject, which includes a classified content, and securely transmits the image taken of the document (document image) to the receiving server 4 via the transmitting server 2 and the firewall 3. After the document image securely reaches the receiving server 4, the purpose is arbitrary and it is possible to convert the document included in the document image into a text and store the text. It should be noted that data other than the document image, for instance audio file, audio data, text data and the like, may be transmitted from the mobile phone 1 to the receiving server 4 and stored. Although the image is typically a still image, it may be a moving image or a moving image with audio. A save format of the image and the audio is arbitrary. For instance, a JPEG file, a WAV file and the like are used.

The mobile phone 1 and the transmitting server 2 are connected to each other by a mobile communication network 5. The mobile communication network 5 and the transmitting server 2 are managed by the same carrier (telecommunications carrier).

The mobile phone 1 typically comprises a mobile phone with a camera. However, an information-communication terminal capable of accessing the mobile communication network 5, for instance a digital camera, a PDA with a camera, and a notebook PC with a camera and the like, can be an alternative to the mobile phone 1. Although the information-communication terminal is not necessarily portable, portability allows the terminal to acquire the document image anywhere, thereby improving convenience.

The mobile phone 1 includes an imaging device 11, an imaging region display unit 12, a display unit 13, a controller 14, an operation unit 15 and storage unit 16. The mobile phone 1 itself does not necessarily include the imaging device 11. An external imaging device 11 may be connected to the mobile phone 1. Note that, in view of security, it is configured such that the taken image of the imaging device 11 should not remain in the imaging device 11.

The imaging device 11 includes: an imaging optical system, such as a zoom lens and a focusing lens, and a driver system thereof; image pickup element, such as a CCD and a CMOS, for photoelectrically converting the subject image received and formed through the imaging optical system; an AD converter converting an analog image signal from the image pickup element into a digital image data; an imaging controller controlling the driver system for varying imaging timing and the focal length and zoom position of the imaging optical system; an image processor applying various image processings such as white balancing to the image data; and a timing generator instructing operation timing of each part.

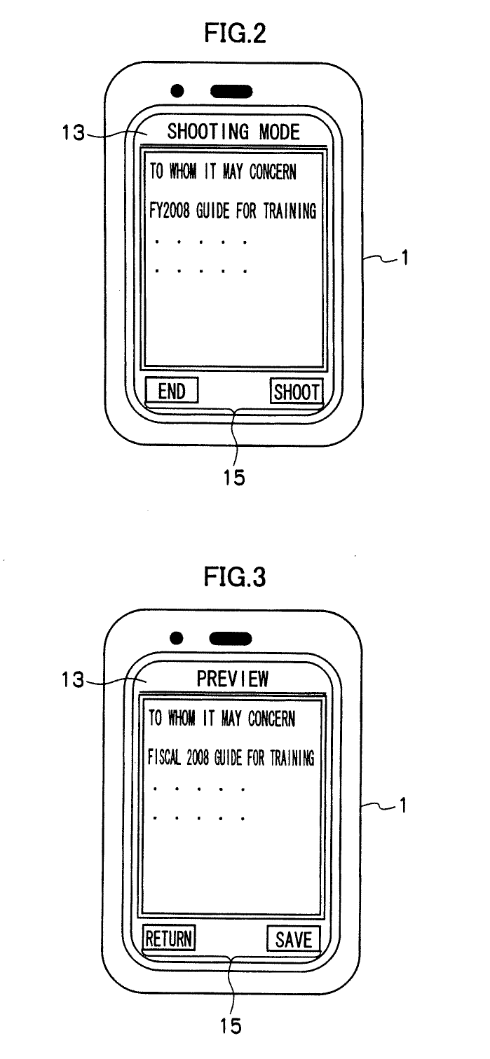

The mobile phone 1, according to the instruction from the operation unit 15 or automatically responsive to power-on, starts a dedicated application, which is stored in the storage unit 16, for taking and transmitting a document image, and starts to display a live view image (continuously provided from the imaging device 11) for representing an imaging angle of view (see FIG. 2). When the controller 14 detects an input of an image-taking instruction (press of a “SHOOT” button displayed on a screen as shown in FIG. 2) to the operation unit 15, the controller 14 instructs the imaging device 11 to start acquiring an image data to be recorded. The imaging device 11 acquires the image data according to the instruction, and temporarily stores the image data in a RAM of the storage unit 16 including rewritable storage medium such as the RAM. When the controller 14 detects an input (press of an “END” button displayed on a screen as shown in FIG. 2) of instructing a cancellation of taking image to the operation unit 15, the controller 14 instructs the imaging device 11 to stop acquiring the live view image and becomes into a standby state where an ordinal telephonic communication function is provided. In the standby state, only the telephonic communication is available. Any input into the operation unit 15 that starts an operation of the imaging device 11 or instruction of taking an image is disabled or ignored (locked), thereby keeping the classified documents away from imaging.

When the controller 14 detects an input (press of a “SAVE” button displayed on a screen as shown in FIG. 3) instructing save, the controller 14 applies a compression process pursuant to a prescribed format (JPEG etc.) to the image data stored in the RAM of the storage unit 16, creates an image file and stores the file in the storage unit 16. When the controller 14 detects an input (press of a “RETURN” button displayed on a screen as shown in FIG. 3) of a cancellation of save to the operation unit 15, the controller 14 discards the image data stored in the RAM of the storage unit 16 and restarts to display the live view image.

The imaging region display unit 12 displays the live view image (see FIG. 2) representing the imaging angle of view on the display unit 13. The display unit 13 comprises a liquid crystal display and the like, and displays the live view image of the imaging device 11 or images (see FIG. 3) having already been taken according to control of the controller 14.

The controller 14 includes a circuit such as a CPU required for computation, and integrally controls operation of the mobile phone 1. The control of the controller 14 is performed according to a program stored in the storage unit 16 including the RAM and the ROM. The program (application) causing the controller 14 to execute a series of processes from image-taking to transmission of data by the mobile phone 1 may be preinstalled or downloadable from the transmitting server 2 via the mobile communication network 5 if required. In all cases, such dedicated application is saved in the mobile phone 1.

The operation unit 15 comprises devices, such as various operation buttons and keys, for detecting an instruction by a user, or alternatives thereof (a circuit for recognizing an instruction by a voice and the like). A detected result of the instruction inputted by the user is inputted into the controller 14, the controller 14 analyzes the result and performs a corresponding control. Although instructions that a user can input in this embodiment include starting imaging, saving an image, finish imaging, and cancellation of saving an image, another instruction (input of a phone number of a telephonic call destination, transmission and reception of email) unrelated to imaging and transmission of an image may be acceptable as an input.

The storage unit 16 can comprise a RAM, a ROM, an EEPROM, a memory card, a hard disk drive or the like. The storage unit 16 stores identification information (ID) uniquely identifying the mobile phone 1. The ID is typically numbers, characters, symbols, codes, or a combination thereof. However, without restriction to this, anything can be used provided that it is unique information. In order to prevent unauthorized alteration, the ID is stored in a storage medium (ROM in the storage unit 16) that cannot be rewritten. Although FIG. 1 shows only one mobile phone 1, a plurality thereof can exist in actuality. In this case, the ID that each mobile phone stores should be different.

A communication device 17 transmits and receives desired data to and from the transmitting server 2 via the mobile communication network 5 according to the control of the controller 14. The communication standard is pursuant to that the carrier having or using the mobile communication network 5 prescribes (e.g. W-CDMA, CDMA2000). The content of data to be transmitted and received pursuant to the communication standard of the carrier may be arbitrary. For instance, a telephonic audio, an image (a still image and a moving image), a text (including email), a hyper text file (including a web page), program (including an applet) and the like can be considered. The controller 14 deletes the document image from the storage unit 16 responsive to the communication device 17 having normally transmitted the document image to the transmitting server 2. In other words, it is performed to prevent the transmitted document image from being used in an unauthorized fashion. It should be noted that the document image and the audio in the storage unit 16 are not necessarily saved as a file on a temporary basis. The acquired data may be transmitted to the transmitting server 2 as it is via the communication device 17. Among a system for transmitting image and audio data in the case of not saving the file, for instance, a videophone function of the “3G-324M” standard (attached to a 3G mobile phone) that uses the MPEG-4 Visual for a moving image and the AMR for an audio can be utilized.

The transmitting server 2 receives data transmitted from the mobile phone 1 via the mobile communication network 5. For instance, the transmitting server 2 receives the image and attribute information thereof, or the ID of the mobile phone 1 having taken the image, from the mobile phone 1. The attribute information may include various pieces of information such as the imaging date and time and photographer. The transmitting server 2 is connected to the mobile communication network 5. Transmission and reception of data via the mobile communication network 5 is pursuant to the communication standard (protocol) specified by the carrier. The protocol is different from that of a typical server (web server or mail server) connected to the Internet. Accordingly, the information terminal pursuant to the protocol adopted in the Internet 6 cannot directly access the mobile phone 1 via the mobile communication network 5.

In order to connect the mobile phone 1 to the mail server and the web server in the Internet 6, it is required that a gateway server converting respective protocols into each other intervenes. However, in order to prevent an image of a classified document from being transmitted to a destination other than the receiving server 4 in an unauthorized fashion, a gateway server (especially, the mail server) other than the transmitting server 2 should not be disposed. Even if such gateway server is disposed, it should be configured such that the mobile phone 1 cannot access the server to transmit data, especially the document image.

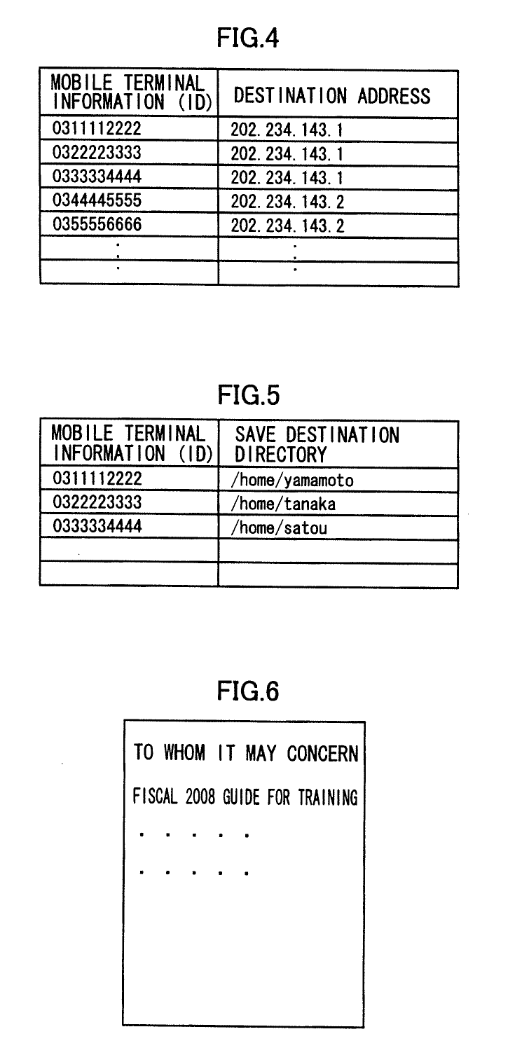

The transmitting server 2 is a computer including a transmitting mobile terminal information management DB 21 (hereinafter represented as transmitting DB 21) and a virtual communication path creation unit 22. Although not shown in the figure, the transmitting server 2 includes a processing device, a storage device, a communication device, a data I/O device, an operation device, a display device and the like, as with a publicly-known computer. The transmitting DB 21 comprises a hard disk drive, and stores the ID of the mobile phone 1 and a destination address indicating the receiving server 4, to which the document image is transmitted, in association with each other (see FIG. 4). The association therebetween can be edited, added and deleted by a user having an authority of an administrator using the operation unit in a desired fashion. The specifics shown in the figure is illustrated only by way of example.

The virtual communication path creation unit 22 forms a VPN 8 (Virtual Private Network) between itself and a virtual communication path creation unit 31 of the FW 3. Although a backbone of the VPN 8 is the Internet 6, a communication data packet passing a path virtually established between the virtual communication path creation unit 22 of the transmitting server 2 and the virtual communication path creation unit 31 of the FW 3 is encrypted according to the IPSec or the like, decrypted by an access controller 32 and subsequently transferred to the receiving server 4 via a LAN 9. An access from an information terminal where the VPN 8 is not formed is limited by authorization of the access controller 32, thereby securing confidentiality of communication. More specifically, the FW 3 only authorizes a communication to the receiving server 4 via the VPN 8, and rejects an access by an information terminal from the Internet 6 to the LAN 9 without intervention of VPN 8. Only with security of communication confidentiality, the communication between the virtual communication path creation unit 22 and the FW 3 is not restricted to have the name, “VPN”. The backbone of the VPN 8 is not necessarily “the Internet”. It may be a public computer network having a name different therefrom. It may also be a combination of the Internet 6 and another public computer network.

The FW 3 performs a function of a gateway that intermediates a connection between the Internet 6 and the LAN 9. The FW 3 may be a personal computer or a hardware (router) having a function of the VPN 8. The FW 3 may integrally be configured with the receiving server 4. Although the FW 3 and the receiving server 4 are connected by the LAN 9, the LAN 9 is not required if the FW 3 and receiving server 4 are integrally formed.

The virtual communication path creation unit 22 refers to the transmitting DB21 and identifies the destination address corresponding to the ID attributed to the image received from the mobile phone 1. If the receiving server 4 is assigned with a unique local IP address in the LAN 9, the destination address managed in the transmitting DB 21 is the IP address in the LAN 9. In actuality, the receiving server 4 can uniquely be identified in the Internet 6 only when the global IP address of the FW 3 is added to the local IP address. However, if there is only one VPN 8, the network between the transmitting server 2 and the receiving server 4 is regarded identical to the LAN 9, thereby allowing the receiving server 4 to be uniquely identified only by the local IP address. Use of a publicly-known technique such as NAT (Network Address Translation) allows the local IP address to be used for the global IP address. If the receiving server 4 is integrally configured with the FW 3 and assigned with the global IP address unique in the Internet 6, the destination address managed in the transmitting DB 21 may be the global IP address of the receiving server 4. Although one VPN 8, one receiving server 4 and one LAN 9 are provided in FIG. 1, the plurality thereof may be provided. The plurality may be those assigned only with the local IP address, those assigned only with the global IP address, or a combination thereof. In effect, it is sufficient that the destination address managed in the transmitting DB 21 be that capable of uniquely identifying each one of the receiving servers 4 connected by the VPN 8.

The virtual communication path creation unit 22 connects via LAN 9 to the receiving server 4 assigned with the identified destination address that resides inside the FW 3, and transmits desired data thereto.

The receiving server 4 comprises a publicly-known personal computer, and includes a character recognition processor 41, a data converter 42, a controller 43 and a receiving mobile terminal information management DB 44 (hereinafter represented as receiving DB 44). The character recognition processor 41 recognizes characters from the image received from the mobile phone 1 via the transmitting server 2, VPN 8, FW 3 and LAN 9. The data converter 42 converts the characters having been recognized from the image by the character recognition processor 41 into text data (see FIG. 6), and creates a document file storing the text data. Processing thereof may be performed in a similar fashion as that in Japanese Patent Application Laid-Open No. 2005-134968 or as a publicly-known technique such as the OCR.

The receiving DB 44 stores the ID of every mobile phone 1, and the document image transmitted from the mobile phone 1, the document file thereof and directory information indicating a save destination directory for another various pieces of data, in association with each other (see FIG. 5). The association therebetween can be edited, added and deleted by a user having an authority of an administrator using the operation device in a desired fashion. The specifics shown in the figure are illustrated only by way of example. The save destination directory is not necessarily a local directory in the receiving server 4. The directory may be a network directory of another computer connected to the receiving server 4 via the LAN 9.

The controller 43 refers to the receiving DB 44, identifies the directory information corresponding to the ID attributed to the document image received from the mobile phone 1, and saves the document file converted from the document image in the directory corresponding to the identified directory information.

The character recognition processor 41 and the data converter 42 may reside in the mobile phone 1 or the transmitting server 2. In this case, the mobile phone 1 or the transmitting server 2 transmits the converted text data or the document file instead of the document image.

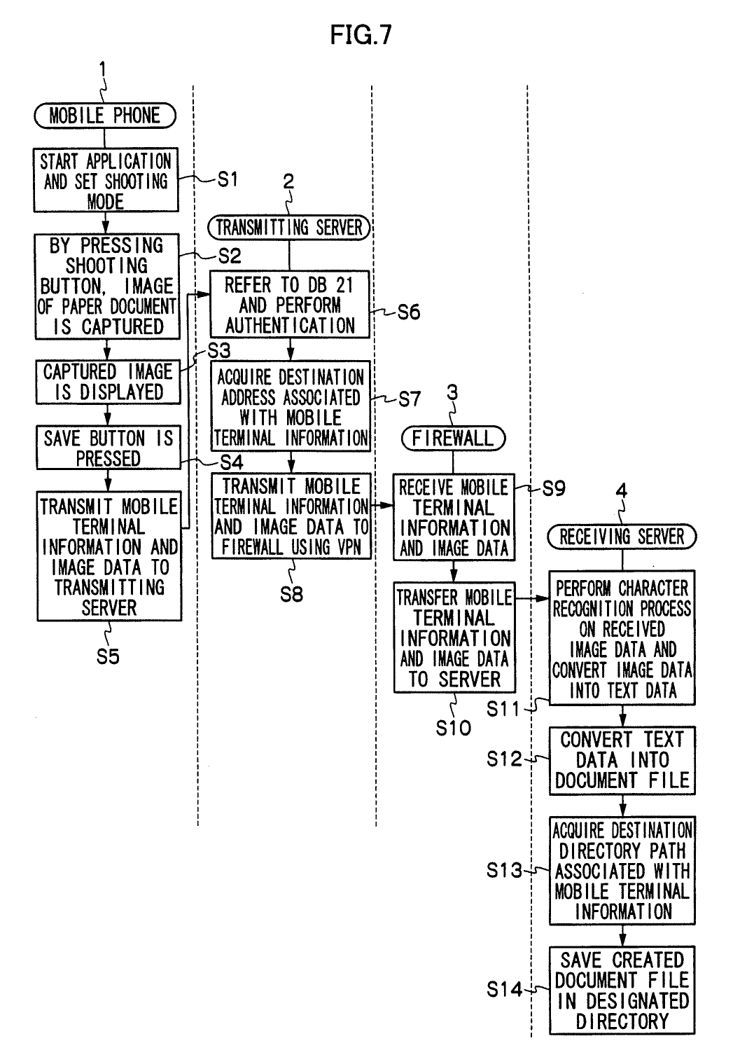

FIG. 7 shows a flowchart of processing executed in this system. The mobile phone 1 executes steps S1 to S5, the transmitting server 2 executes steps S6 to S8, the FW 3 executes steps S9 to S10, and the receiving server 4 executes steps S11 to S14. Programs for causing the respective apparatuses to execute these processes are stored in storage mediums in the respective apparatuses. These programs are read and executed by controllers or CPUs included in the respective apparatuses. The storage mediums may be a semiconductor device such as a ROM or a RAM. Instead, the mediums may be a portable storage medium such as a memory card, a DVD or a CD-ROM. In effect, a storage destination of the program may be anything provided that it is a computer readable storage medium. Instead, the program may be distributed from a prescribed server via the Internet 6.

In step S1, the mobile phone 1 starts the application and causes the imaging device 11 to be standby. Responsive to this, the live view image begins to be displayed (see FIG. 2).

In step S2, the mobile phone 1 starts to acquire image data to be recorded, responsive to an input of the instruction of imaging. The subject includes a document. The acquired image data is saved in the storage unit 16.

In step S3, the mobile phone 1 displays the image data to be recorded, which is saved in the storage unit 16, on the display unit 13 (see FIG. 3).

In step S4, the mobile phone 1 advances the processing to step S5 responsive to an input of an instruction of saving the image.

In step S5, the image data to be recorded is converted into an image file in a prescribed format and saved in the storage unit 16. On this occasion, the ID stored in the storage unit 16 is written as the attribute information (tag information, header information and the like) of the image file. The image file is transmitted to the transmitting server 2 via the mobile communication network 5. After completion of the transmission, the image file is deleted from the storage unit 16.

In step S6, the transmitting server 2 checks the ID attributed to the image file received from the mobile phone 1 via the mobile communication network 5 against the ID stored in the transmitting DB 21, and determines whether or not the received ID matches any one of the IDs stored in the transmitting DB 21. If any match exists, the mobile phone 1 is authenticated to be the authorized originator and the image file is taken into a prescribed storage medium. If no match exists, the received image file is discarded.

In step S7, the transmitting server 2 refers to the transmitting DB 21 and identifies the destination address corresponding to the received ID.

In step S8, the transmitting server 2 encrypts the received image and the attribute information (ID etc.), and transmits the encrypted image and attribute information to the FW 3 via the VPN 8 connected to the LAN 9 assigned with the identified destination address. It is sufficient that the image and audio be encrypted and transmitted via the VPN 8. The transfer system (protocol) of the image and audio themselves may be arbitrary selected. For instance, in order to transmit an image and audio file, the VPN 8 and the FTP (File Transfer Protocol) can preferably be combined. When image and audio data not having been packed in a file yet is received from the mobile phone 1, the received image and audio data can preferably be transmitted in combination of a streaming transport system such as the RTP (Real-time Transport Protocol) with the VPN 8.

In step S9, the FW 3 receives the image and the attribute information from the transmitting server 2 via the VPN 8, and decrypts the image and the attribute information.

In step S10, the FW 3 transmits the decrypted image and attribute information to the receiving server 4 via the LAN 9.

In step S11, the receiving server 4 performs the character recognition process on the received image and converts the image into a text data. If the received data is not a separated still image but for instance is streaming data and the like, conversion into still images by capturing enables the character recognition process to be performed therefrom.

In step S12, the receiving server 4 converts the text data into a document file.

In step S13, the receiving server 4 refers to the receiving DB 44 and identifies the directory information corresponding to the ID included in the received attribution information.

In step S14, the receiving server 4 saves the document file in the directory corresponding to the directory information identified in step S13. The document image and the attribute information thereof may be saved in the directory with the document file. Instead, the document image itself may be saved in the directory without creation of the document file.

As set forth above, the image of the document printed on a piece of paper is taken by the mobile phone 1, the acquired document image is transmitted to the transmitting server 2 via the mobile communication network 5, the transmitting server 2 transmits the document image to the receiving server 4 via the VPN 8 in the Internet 6 and in turn the receiving server 4 saves the document image received from the transmitting server 2. Since unauthorized acquisition and alteration through the mobile communication network 5 and the VPN 8 are practically impossible, the document image taken by the mobile phone 1 can securely be transmitted to the remote receiving server 4.

Various pieces of data other than the document image, for instance an audio file, a program and text data itself, can securely be transmitted via the above-mentioned communication path. The applicable scope of the present invention is not limited to transmission of image data. In particular, if the mobile phone 1 includes an audio recording unit (well known as a name of voice memo) that records an audio collected from a microphone as audio data or an audio file, the mobile phone 1 transmits an audio data digitally converted from an spoken audio based on an important document or an audio file recording the audio instead of or together with the document image. The character recognition processor 41 can also recognize an audio content from audio data or an audio file using a voice recognition technique, and the data converter 42 can convert the recognized audio content into a document file and save the file in a directory designated in the receiving DB 44. The text data representing the character strings inputted through the operation unit 15 of the mobile phone 1 can also be securely transmitted via the above-mentioned communication path. In this case, the receiving server 4 can save the text data as it is in the directory designated in the receiving DB 44.

As set forth above, if the character recognition processor 41 and the data converter 42 are provided in the mobile phone 1, the mobile phone 1 can display the content of the document file converted from the audio data on the display unit 13, as with the image having already taken, and let the user visually confirm the audio content.

When both the image and audio are transmitted, it can also be configured such that a document file converted from an image and a document file converted from an audio are checked against each other, a match, a mismatch and a lack of information are highlighted, the lacking information of one document file is complemented with the corresponding information in the other document file according to an input of confirmation by the user and is overwritten. This allows the document file to be complemented using the clear one even when the other image is unclear or the other audio is partially unclear and the corresponding document file lacks a part of information.

What is claimed is:

1. A linguistic content management method, comprising the steps of:
acquiring a linguistic content including data representing information by language which is executed by an information-communication terminal, and connecting to a transmitting server pursuant to a prescribed communication standard of a mobile communication carrier and transmitting the linguistic content to the transmitting server which is executed by the information-communication terminal,
receiving the linguistic content pursuant to the prescribed communication standard of the mobile communication carrier which is executed by the transmitting server, and connecting to a receiving server via a virtual dedicated communication path in a public network and transmitting the linguistic content to the receiving server which is executed by the transmitting server, and
receiving the linguistic content via the virtual dedicated communication path which is executed by the receiving server, and saving the received linguistic content which is executed by the receiving server.

2. The linguistic content management method according to claim 1, wherein
the information-communication terminal executes a step of transmitting identification information of the information-communication terminal with the linguistic content, and
the transmitting server executes a step of storing destination information corresponding to the identification information of each information-communication terminal in a destination database, a step of receiving the identification information of the information-communication terminal with the linguistic content pursuant to the prescribed communication standard of the mobile communication carrier, and a step of transmitting the linguistic content to the receiving server identified by the destination information corresponding to the received identification information in the transmitting database.

3. The linguistic content management method according to claim 2, wherein
the transmitting server executes a step of transmitting the identification information of the information-communication terminal with the linguistic content, and
the receiving server executes a step of storing storage destination information corresponding to the identification information of each information-communication terminal in a storage destination database, a step of receiving the identification information of the information-communication terminal with the linguistic content via the virtual dedicated communication path, and a step of storing the linguistic content in a storage destination identified by the storage destination information corresponding to the received identification information in the storage destination database.

4. The linguistic content management method according to claim 1, wherein the information-communication terminal executes a step of deleting the linguistic content transmitted to the transmitting server, from a prescribed storage medium.

5. The linguistic content management method according to claim 1, wherein the information-communication terminal executes a step of displaying an imaging angle of view when taking an image of a subject including a document.

6. The linguistic content management method according to claim 1, wherein the information-communication terminal executes a step of displaying the acquired linguistic content.

7. The linguistic content management method according to claim 1, wherein the information-communication terminal executes a step of transmitting the linguistic content to the transmitting server responsive to input of an instruction of transmitting the acquired linguistic content.

8. The linguistic content management method according to claim 1, wherein the linguistic content includes at least any one of an image data acquired by taking an image of a subject including a document and audio data representing a collected speech content.

9. A linguistic content management system, comprising:
an information-communication terminal that includes a linguistic content acquisition device that acquires a linguistic content including data representing information by language, and a terminal transmitter device that connects to a transmitting server pursuant to a prescribed communication standard of a mobile communication carrier and transmits the linguistic content to the transmitting server;
the transmitting server that includes a transmitting server receiver that receives the linguistic content pursuant to the prescribed communication standard of the mobile communication carrier, and a transmitting server transmitter that connects to a receiving server via a virtual dedicated communication path in a public network and transmits the linguistic content to the receiving server; and
the receiving server that includes a receiving server receiver that receives the linguistic content via the virtual dedicated communication path, and a saving device that saves the received linguistic content.

10. The linguistic content management system according to claim 9, wherein the virtual dedicated communication path includes a VPN (Virtual Private Network).

11. The linguistic content management system according to claim 9, further comprising a communication path establishment device that establishes the virtual dedicated communication path with the transmitting server.

12. The linguistic content management system according to claim 11, wherein the communication path establishment device limits an access path originating from the public network and bound for the receiving server to the virtual dedicated communication path.

13. The linguistic content management system according to claim 12, wherein the communication path establishment device is a gateway provided between the public network and a LAN (Local Area Network) to which the receiving server is connected, and an access path from the transmitting server to the receiving server via the public network and the LAN is limited to the virtual dedicated communication path.

14. A linguistic content management method, comprising the steps of:
receiving from an information-communication terminal a linguistic content including data representing information by language pursuant to a prescribed communication standard of a mobile communication carrier, which is executed by a transmitting server, and
connecting to a receiving server via a virtual dedicated communication path in a public network and transmitting the linguistic content to the receiving server, which is executed by the transmitting server.

15. The linguistic content management method, according to claim 14, wherein the receiving server executes a step of receiving the linguistic content via the virtual dedicated communication path, and a step of saving the received linguistic content.

16. A programmable storage medium tangibly embodying a program of machine-readable instructions to the transmitting server to execute the linguistic content management method according to claim 14.

17. A programmable storage medium tangibly embodying a program of machine-readable instructions to the receiving server to execute the linguistic content management method according to claim 15.

18. A linguistic content transmitting apparatus, comprising:
a receiver that receives from an information-communication terminal a linguistic content that is content data representing information by language pursuant to a prescribed communication standard of a mobile communication carrier; and
a transmitter that connects to a linguistic content receiving apparatus via a virtual dedicated communication path in a public network and transmits the linguistic content received by the receiver to the linguistic content receiving apparatus.

19. A linguistic content receiving apparatus, comprising:
a linguistic content receiver that receives the linguistic content from the linguistic content transmitting apparatus according to claim 18 via the virtual dedicated communication path; and
a saving device that saves the linguistic content received by the linguistic content receiver.

20. The linguistic content receiving apparatus according to claim 19, further comprising a document data converter that converts a document included in the linguistic content received by the linguistic content receiver into document data and outputs the document data, wherein the saving device saves the document data outputted by the document data converter.
